(19) United States
(12) Patent Application Publication
(10) Pub. No.: US 2015/0279149 A1
(43) Pub. Date: Oct. 1, 2015

(54) METHODS AND SYSTEMS FOR MAINTAINING CUSTOMER LOYALTY

(71) Applicant: KIZZANG LLC, Las Vegas, NV (US)

(72) Inventor: Robert Alexander, Las Vegas, NV (US)

(21) Appl. No.: 14/231,364

(22) Filed: Mar. 31, 2014

(51) Int. Cl. G07F 17/32

(52) U.S. Cl. CPC G07F 17/326

(57) ABSTRACT

A sweepstakes provides a virtual prize wheel having segments populated with prizes available to be won by a player. A first spin of the prize wheel determines how one or more segments of the prize wheel are populated. A second spin of the prize wheel determines the prize(s) won by the player for a specified turn. Player loyalty is encouraged by varying aspects of the prize wheel, for example, the number of prize wheel segments, the number of such segments populated with cash prizes, and the value of those cash prizes, according to a predetermined schedule, with the prizes, prize values and prize wheel segments being reset to a set of initial conditions if a player fails to participate in a qualifying event for a prize wheel turn within a designated time period.

### FIELD OF THE INVENTION

The present invention relates to on-line gaming, and more specifically to a sweepstakes for use in connection with an on-line service as a means of ensuring customer loyalty to the service.

### BACKGROUND

Merchants commonly use sweepstakes as a means of generating repeat customers. For example, some restaurants employ sweepstakes in which game pieces are provided to customers on each visit and the customers use the game pieces to win (or attempt to win) prizes. Some states also use sweepstakes as a means of offering “second chances” to win lottery prizes, thereby driving demand for lottery tickets. In such instances, the prizes associated with the sweepstakes are generally fixed at the time the sweepstakes promotion commences and do not change regardless of the number of entries a player submits.

### BRIEF DESCRIPTION OF THE DRAWINGS

The present invention is illustrated by way of example, and not limitation, in the figures of the accompanying drawings, in which:

FIG. 1 illustrates an example of a network environment within which embodiments of the invention may be instantiated.

FIG. 2 illustrates an example of a web page including an advertisement that may be provided by a server to a client in accordance with embodiments of the invention.

FIG. 3 illustrates an example of a web page that includes a prize wheel that may be provided by a server to a client in accordance with embodiments of the invention.

FIG. 4 illustrates further details of the prize wheel shown in FIG. 3.

FIG. 5 illustrates an example of a control system for the prize wheel shown in FIGS. 3 and 4.

FIG. 6 illustrates an example of a computer system in which embodiments of the invention may be instantiated.

### DETAILED DESCRIPTION

In various embodiments, the present invention provides methods and systems for maintaining customer loyalty. In one instance, the present invention provides a sweepstakes for use in connection with an on-line service as a means of ensuring customer loyalty to the service. The sweepstakes may be instantiated in various forms. In one such form, a virtual prize wheel is presented to a player and one or more segments of the prize wheel are populated with prizes available to be won by the player. The prizes may include passes that allow the player to play one or more on-line games (e.g., games of chance, other sweepstakes, entertainment games, etc.), coupons (e.g., for merchandise, services, or the like), goods or services, and/or cash. A player “turn” may consist of two virtual spins of the prize wheel. A first spin of the prize wheel may determine how one or more segments of the prize wheel are populated—that is, which prizes are associated with one or more of the prize wheel segments. A second spin of the prize wheel may determine the prize(s) won by the player for the specified turn. Players may be afforded one or more turns per visit to the on-line service and/or per time period, for example up to a predetermined number of turns per day, in exchange for viewing one or more advertisements or fulfilling other specified conditions. Player loyalty (e.g., in the form of multiple return visits to one or more web sites associated with the on-line service) may be encouraged by varying the prizes available to be won. For example, in one embodiment of the invention the number of prize wheel segments, the number of such segments populated with cash prizes, and the value of those cash prizes are varied according to a predetermined schedule, with the prizes, prize values and prize wheel segments being reset to a set of initial conditions if a player fails to participate in a qualifying event for a prize wheel turn within a designated time period. These and further details of the present invention are described in greater detail below.

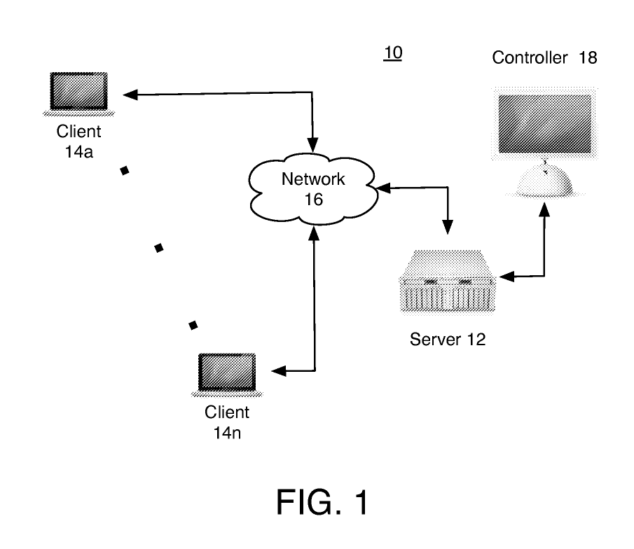

Before describing the present invention in detail it is helpful to provide an overview of the environment in which embodiments of the invention may be deployed. FIG. 1 illustrates an example of such an environment 10. In this example, server 12 hosts an on-line service through which any of a variety of goods or services may be purchased and/or used. For example, server 12 may host one or more web sites offered by a service provider, which web sites offer on-line games for users. The games may include entertainment games, casino games, wagering games, etc. Alternatively, or in addition, movies, music or other forms of entertainment may be accessed through one or more of these web sites. Also, the web sites may offer goods or other services for lease or purchase by visitors. Indeed, the nature of the web sites hosted by server 12 is not critical to the present invention, however, it is preferable that the web sites be offered only to visitors that have registered for access to same, thereby allowing individual users to be identified each time they visit. Although illustrated as a single server, it should be appreciated that server 20 may in fact be multiple servers and may be segregated into web servers that are communicably coupled to one or more application servers, which themselves are communicably coupled to one or more databases storing user information, game information and other data.

Users (and herein the term player may be used interchangeably with the term user) access web sites and other facilities hosted by server 12 through clients 14a-14n. Examples of such clients include desktop computers, laptop computers, cellphones, smart phones, tablet computers, computer game consoles, portable computer gaming consoles, media players, portable media players, other mobile devices, and the like. Typically, clients 14a-14n communicate with server 12 over one or more networks 16, for example the Internet. Clients 14a-14n are preferably configured with applications that allow for the display of web pages. Such applications include web browsers and dedicated applications capable of rendering web pages and the like.

Also shown in FIG. 1 is a controller 18 that is communicably coupled to server 12. Controller 18 is a facility for the service provider associated with the web sites hosted at server 12 to maintain and otherwise configure those sites. In some instances, controller 18 may communicate with server 12 via network 16, while in other cases the communication may be over a virtual private network or the like and so is shown as a separate connection in the diagram.

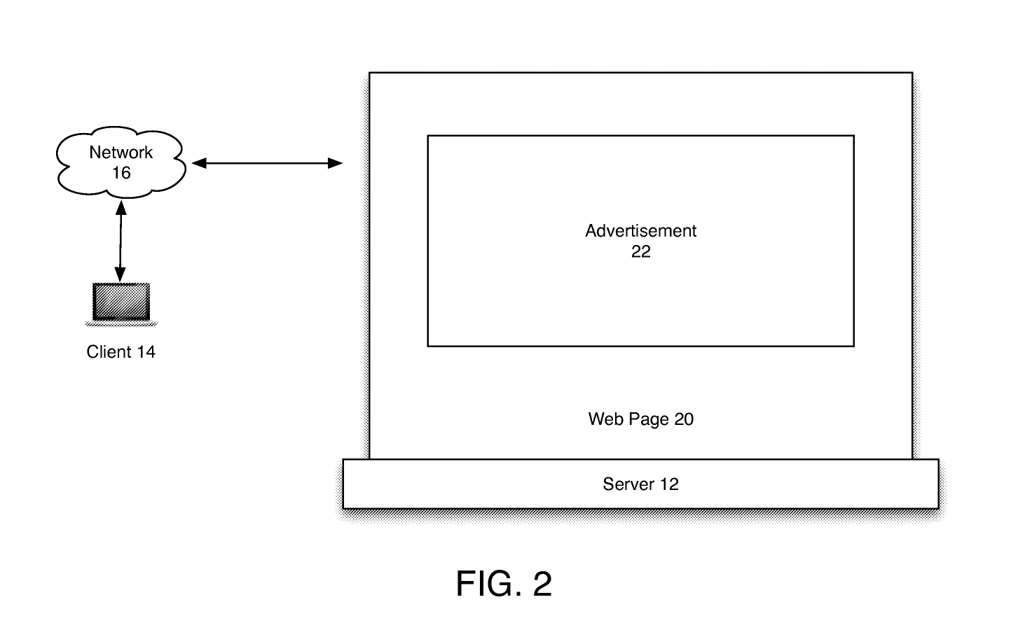

Referring now to FIG. 2, when a player at client 14 accesses a service associated with a web site hosted at server 12, the player may be required to log-in (e.g., by presenting a user name and password). Upon successful verification of the player's credentials, a web page 20 that includes an advertisement 22 may be presented. Viewing the advertisement 22 (or multiple such advertisements) may be a condition of being permitted access to the services associated with the web sites hosted by server 20 and the player's agreement to view such advertisements may be part of the terms of service agreed to by the player when he/she enrolls with the service provider. The advertisement 22 may be any form of advertisement and may comprise one or more images, text materials, movies, audio-video presentations, etc. Although the user may be provided an opportunity to “skip” the advertisement and navigate directly to other web pages, server 12 is preferably configured to detect such navigation commands (typically in the form of mouse click or similar events associated with a hyperlink away from web page 20). Upon recognizing such a navigation command, server 20 will not present the player an opportunity to spin the prize wheel and any accumulated loyalty grants may be eliminated from the player's account.

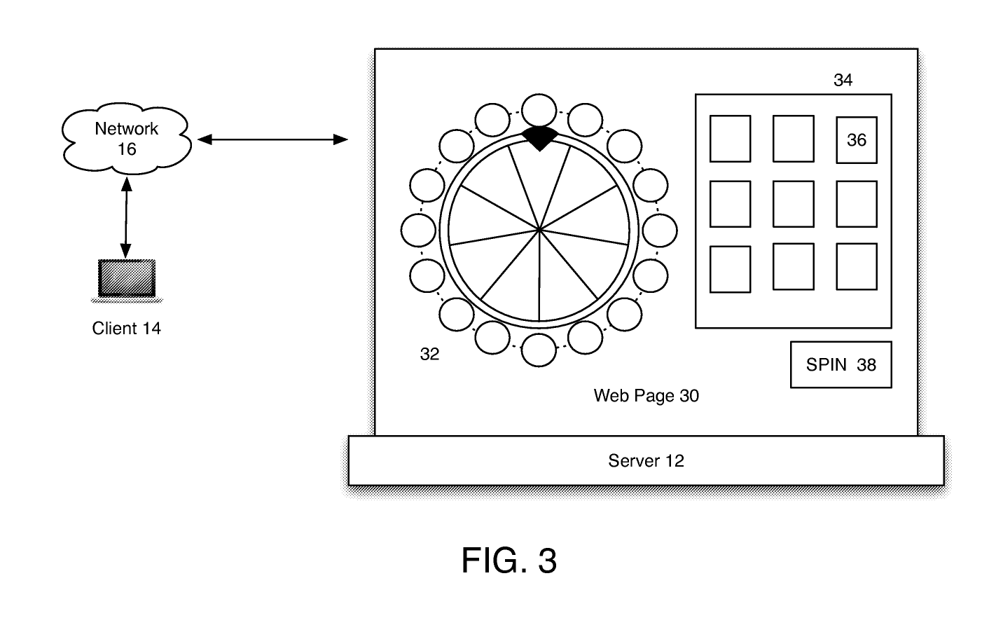

Assuming the player views the advertisement through its conclusion (e.g., if the advertisement is a move or audio-video presentation) or for at least a designated period of time (e.g., specified by a count down timer or the like displayed in conjunction with web page 20), server 12 will present web page 30, shown in FIG. 3, to the player (e.g., via a web browser associated with client 14). Web page 30 includes the prize wheel 32 and an associated information panel 34. In one embodiment, information panel 34 may include designators 36 that indicate the schedule for modifying the prize wheel and/or possible cash prizes associated therewith. For example, the designators may be calendar days or the like. Web page 30 may also include a virtual spin button 38, which when selected by a user (e.g., with a mouse click or similar cursor control action) may cause the prize wheel 32 to spin. In other embodiments spin button 38 may be absent and the prize wheel may be activated automatically by server 12 (e.g., a predetermined time after the web pages has been loaded by the browser running on client 14).

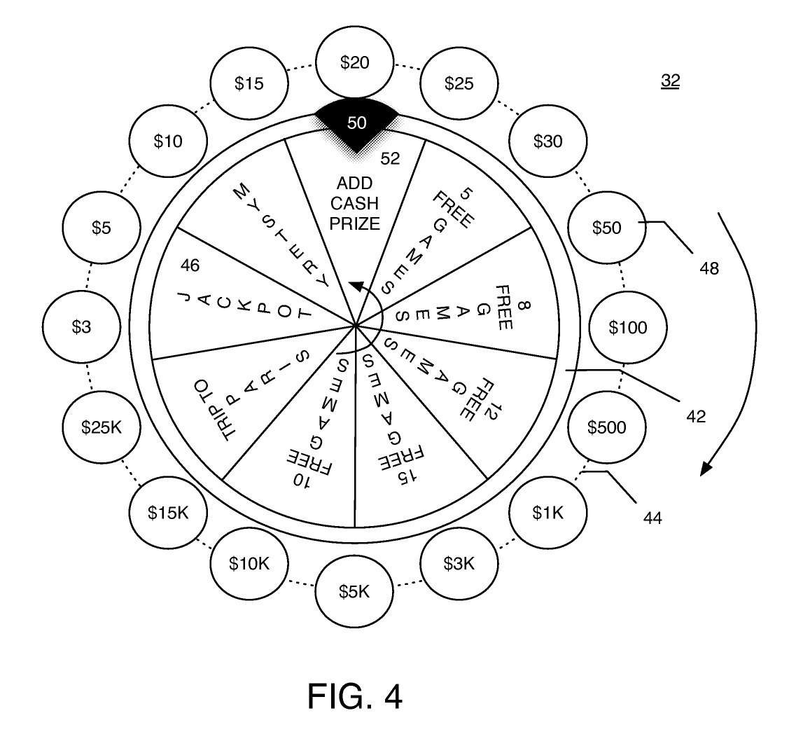

FIG. 4 illustrates an example of the prize wheel 32 in greater detail. In this example, prize wheel 32 includes an inner wheel 42 and an outer wheel 44. The inner wheel 42 includes a plurality of segments 46, each associated with a prize. Prizes may include trips, merchandise, services, coupons for merchandise or services, passes or other tokens that allow for free game play (or other services) at the associated web site (e.g., games of chance, other sweepstakes, entertainment games, etc.), etc. Jackpot prizes (e.g., cumulative cash amounts not won during previous spins of the wheel), mystery prizes (where the prize is revealed only after the wheel stops) and other prizes may also be designated. At least one segment 52 is designated as an “ADD CASH PRIZE” segment.

Outer wheel 444 includes a plurality of cash prize indicators 48. The cash prize indicators are each associated with designated cash amounts. The cash amounts may range in value from low dollar values to high dollar values. The illustrated embodiment shows cash prizes of $3, $5, $10, $15, $20, $25, $30, $50, $100, $500, $1,000 (designated as $1K in the illustration), $3,000, $5,000, $10,000, $15,000, and $25,000, but this is merely an example and in practice any cash values may be used. Cash prizes may, in some instances, be progressive (across prior player turns from prior visits, across all player turns in a given time period, across all turns of all players on a given day, etc.)

At the top of the prize wheel (or in another location), is an indicator 50. Indicator 50 serves to distinguish both a cash prize to be added to the prize wheel (during a first spin of a player turn) and a prize to be awarded (during a second spin of a player turn). As indicated above, a player turn consists of two spins of the prize wheel. The first spin of the prize wheel causes both wheels to spin (e.g., in opposite, or the same direction(s) as one another about a common central axis). When the wheels come to a stop, the cash prize amount designated by the cash prize indicator pointed to by indicator 50 is added to segment 52 of the inner wheel 42 (at the conclusion of the first spin, segment 52 is always stopped so that it is pointed to by indicator 50). Once the cash value has been so added, the second spin of the prize wheel may cause one or both of the inner and outer wheels to spin (e.g., in the same or opposite directions as one another about a common central axis). When the wheel(s) come to a stop, the prize associated with the inner wheel segment 46 pointed to by indicator 50 is awarded to the player. Spins may be initiated by the player by selecting the spin button 38 (if present) or may be initiated automatically by server 30. Each player may be afforded one or more turns per visit to the on-line service and/or per time period (e.g., every 8 hours), for example up to a predetermined number (e.g., 3) of turns per day, in exchange for viewing one or more advertisements or fulfilling other specified conditions.

As mentioned above, player loyalty (e.g., in the form of multiple return visits to one or more web sites associated with the on-line service) may be encouraged by varying the prizes available to be won. In one embodiment of the invention, the number of prize wheel segments 46, the number of such segments populated with cash prizes 52, and/or the value of those cash prizes may be varied according to a predetermined schedule. For example, the number of prize segments 46 may be increased each day, every other day, weekly, semi-monthly, monthly, quarterly, semi-annually, or according to another schedule, up to a maximum number of segments (e.g., 20) within a given 365-day period. Alternatively, or in addition, the number of cash prize segments 52 to be populated may be increased each day, every other day, weekly, semi-monthly, monthly, quarterly, semi-annually, or according to another schedule, up to a maximum number of cash prize segments within the 365-day period. Still further, the values of the cash prizes may be varied, with larger cash prizes being available for inclusion in the cash prize segments 52 on a daily, weekly, semi-monthly, monthly, quarterly, semi-annually, or other basis, up to a set of maximum cash prize values within the 365-day period. In one particular embodiment, the number of segments 46 and the number of cash prize segments 52 are varied according to the schedule shown in Table 1.

TABLE 1
Example of Prize Wheel Variations

| DAY | # of Prize Wheel Segments | # of Cash Prize Segments |
|---|---|---|
| 1 | 9 | 1 |
| 2 | 10 | 2 |
| 3 | 11 | 3 |
| 5 | 12 | 4 |
| 7 | 13 | 5 |
| 10 | 14 | 6 |
| 14 | 15 | 7 |
| 30 | 16 | 8 |
| 45 | 17 | 9 |
| 60 | 18 | 10 |
| 75 | 19 | 11 |
| 90 | 20 | 12 |
| 120 | 20 | 13 |
| 150 | 20 | 14 |
| 240 | 20 | 15 |
| 365 | 20 | 20 |

It is worth noting that in the above example represented in Table 1, the variations among prize wheel segments and the number of cash prize segments is designed to entice players to visit the site regularly for long periods of time (e.g., at least daily for 365 consecutive days. In this example, players are notified that prize values and prize wheel segments will be reset to their initial conditions (i.e., day 1 conditions of 9 prize wheel segments with 1 cash prize segment) if a player fails to participate in a qualifying event for a prize wheel turn (e.g., visit the web site and view at least one advertisement through completion) within a designated time period (e.g., a 24 hour period). The number of prize wheel segments is increased according to the above schedule until a total of 20 segments are included on the prize wheel. Concurrently, the number of cash prize segments is increased according to a second schedule such that on day 365 all 20 of the prize wheel segments are cash prize segments (i.e., the player is assured of winning a cash prize). The cash prize segments may be populated in accordance with the above-described method (e.g., as the result of a first spin of the prize wheel in a given turn). In some cases, all cash prize segments may be populated as a result of the first spin (in which case multiple indicators 50 may be used for cash prize segment population) or the cash prize segments may be populated using a umber of spins, with each spin populating a single cash prize segment. In this latter instance, cash prizes from outer wheel 44 used to populate one cash prize segment 52 may or may not be reused in successive spins to populate other cash prize segments 52.

In other embodiments, rather than having a prize wheel populated in the above-described fashion, on day 365 the player may be presented with a new prize wheel having only cash and prizes available to be won. In some instances, a first spin of the wheel may be used to determine a number of cash prize and or other prize spins awarded to the player, in which instance the cumulative total of these spins would be the player's awarded prize.

After a complete cycle of prize wheel segment and cash prize segment variations, e.g., on day 366 in any of the above-described examples, the prize wheel may be replaced by a different form of sweepstakes, by a different form of prize wheel, or an alternative customer loyalty encouragement device. It should be appreciated that the time periods described in the above examples are solely for purposes of illustration and in practice any schedule desired by the service provider may be used. Players having different loyalty levels (e.g., attained through visits to the subject web site or to affiliate web sites or establishments) may be presented different prize wheels (or other sweepstakes mechanisms) at different times (e.g., according to different schedules).

In all of the examples described herein, some or all of the cash prizes associated with outer wheel 44 may be replaced with other prizes, such as merchandise, services, trips, additional spins, etc. In the case of cash prizes, winnings may be distributed to the player by deposit to an existing player account, to a bank account designated by a player, to another financial institution account designated by the player (including an on-line account at a financial service provider such as PAYPAL), or by check. Other prizes may be shipped to the player at a designated address or, in the case of prizes amenable to distribution by way of email, through email. Alternatively, or in addition, players may be invited to collect their prizes in person at a designated location, such as the office of the service provider.

Determining which cash prize will populate a cash prize segment, and, hence, the corresponding rotations of inner and outer wheels 42 and 44, is performed by server 12 using one or more pseudo-random number generators. The virtual spin wheel segments and cash prize indicators are tokenized and the output(s) of the pseudo-random number generator(s) is(are) compared to the tokens to determine the cash prize that will populate a given cash prize segment. Similarly, the determination of which prize is awarded to a player in a given spin of the prize wheel is made on the basis of the output of a pseudo-random number generator. The prize wheel segments are tokenized and the output of the random number generator determines where the prize wheel will stop (i.e., which segment will be indicated by indicator 50). In advance of any wheel spins, the service provider assigns winning percentages to the various prizes (much in the same way winning percentages are programmed for a casino slot machine) and those percentages are used to produce seeds to control the output of the pseudo-random number generator.

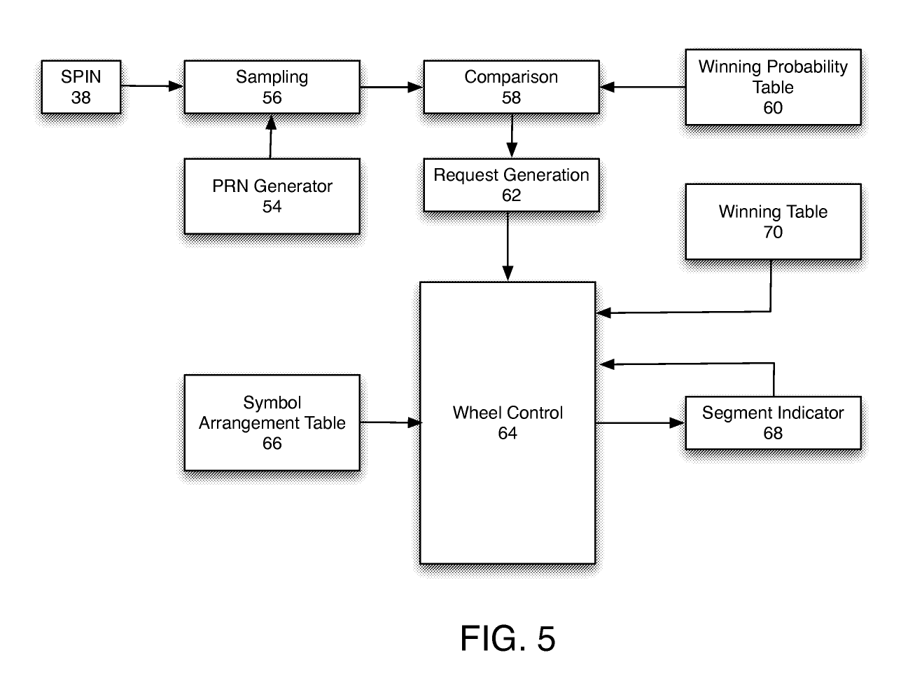

FIG. 5 illustrates an example of how the prize wheel is controlled. At any time instant when the spin button 38 is actuated (or when the wheels are spun by server 12), the pseudo-random number (PRN) generator 54 is sampled 56. The sampled value is compared 58 against a winning probability table 60 to generate a request 62. Through reference to a symbol arrangement table 66 (which stores the assignment of prizes to segments) and a winning table 70 (which stores the service provider's designated pay table for the prize wheel), the wheel controller 64 stops the wheel so the corresponding segment (i.e., the segment that corresponds to the request based on the generated PRN) appears under the segment indicator 68. The spinning of the wheel on the screen is a simulated graphical effect for the entertainment of the player rather than an actual determination of the winning segment.

Returning to FIG. 3, information panel 34. In one embodiment, designators 36 in information panel 34 may specify the schedule for modifying the prize wheel and/or possible cash prizes associated therewith, as reflected in Table 1. For example, the designators may be calendar days or the number of days until the next update of the prize wheel.

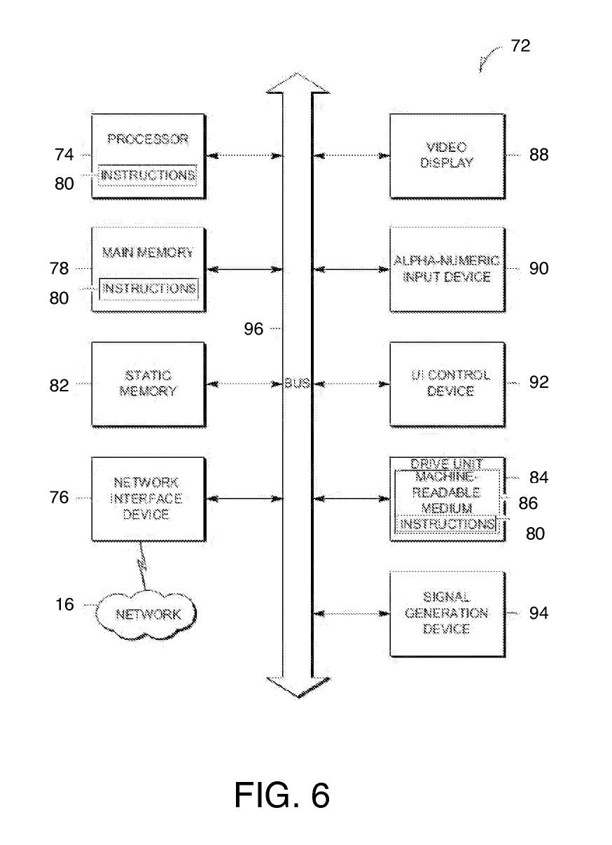

As evident from the foregoing discussion, one or more of the methods or processes described herein may be executable on various computer-based devices (e.g., clients 14a-14n and/or server 12). Such devices, an example (72) of which is illustrated in FIG. 6, may include any electronic device capable of performing the actions described above (using suitable programming) and, where applicable, processing the information for display so as to properly convey the information. Examples of such devices include desktop computers, laptop computers, cellphones, smart phones, tablet computers, computer game consoles, portable computer gaming consoles, media players, portable media players, other mobile devices, and the like.

In such devices, a processor 74 may control the overall functions of the electronic device such as running applications and controlling peripherals. Such a processor may be any type of processor and may communicate (e.g., via bus 96) with network interface device 76 to transmit and receive signals (e.g., cellular, Bluetooth, Wi-Fi, WiLAN, or other communication signals) over a network 16. The processor may use main memory 78 and/or a cache to store operating instructions 80 and to help in the execution of the operating instructions (e.g., such as the temporary storage of calculations and the like). The processor may also use non-transitory storage 82 and/or long-term storage 84 (such as a flash drive, hard disk or other unit comprising a tangible machine readable medium 86) to store and read instructions, files, and other data that requires long term, non-volatile storage.

The processor may communicate and control other peripherals, such as a display 88 with associated touch screen sensor, causing images to be displayed on the display and receiving input from the touch screen sensor when a user presses on the touch-screen display. In some examples, a touch screen sensor may be a multi-touch sensor capable of distinguishing and processing gestures.

The processor may receive input from a physical keyboard 90 and/or mouse/touch pad 92. In other examples, the device may utilize a touch screen keyboard using the display and touch screen sensor. The processor may produce audio output and other alerts that are played on a speaker or other signal generation device 94. A microphone (not shown) may be used as an input device for the processor to receive commands using voice-processing software. In the case of a client 14, an accelerometer may provide input on the motion of the device to the processor. An accelerometer may be used in motion sensitive applications, or, for example, in connection with scrolling content using tilting gestures, etc.

A Bluetooth module may be used to communicate with Bluetooth-enabled external devices. A USB port may enable external connections to other devices (e.g., mice or other cursor control devices) supporting the USB standard and charging capabilities. An external storage module may include any form of removable physical storage media such as a flash drive, micro SD card, SD card, Memory Stick, and the like.

Certain embodiments are described herein as including logic or a number of components, modules, or mechanisms. Modules or components may constitute software modules (e.g., code embodied on a non-transitory machine-readable medium) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connects the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some example embodiments, the processor or processors may be located in a single location, while in other embodiments the processors may be distributed across a number of locations.

The one or more processors may also operate to support performance of the relevant operations in a “cloud computing” environment or as a “software-as-a-service” (SaaS) service. For example, at least some of the operations may be performed by a group of computers (as examples of machines including processors), with these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The foregoing description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” and the like are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. For example, the code can be stored on one or more non-transitory, or non-volatile tangible computer-readable media, and may be loaded into volatile media during execution or at other times (e.g., during a transfer between storage devices, etc.). Examples of these tangible computer-readable media can include, but are not limited to, hard disks, removable magnetic disks, removable optical disks (e.g., compact disks and digital video disks), magnetic cassettes, memory cards or sticks, read only memories (ROMs), flash memories or other solid state devices (SSDs) and the like.

What is claimed is:

1. A method of providing a sweepstakes opportunity to a player, comprising:
presenting the player, via a web site hosted at a first computer system, a virtual prize wheel comprising a plurality of segments, a first number of which segments of the prize wheel are populated with prizes available to be won by the player and a second number of the prize wheel segments to be populated with prizes selected according to an outcome of a first spin of the prize wheel;
as a result of the first spin of the prize wheel populating the second number of the prize wheel segments with prizes determined according to the first spin;
as a result of a second spin of the prize wheel awarding a prize determined by an outcome of the second spin to the player.

2. The method of claim 1, wherein the second number of the prize wheel segments is populated with cash prizes determined according to the first spin.

3. The method of claim 2, wherein the prize wheel comprises an inner wheel and an outer wheel, the inner wheel made up of the prize wheel segments and the outer wheel made up of indicators of cash prizes available to populate the second number of the prize wheel segments and wherein both the inner wheel and the outer wheel spin during the first spin of the prize wheel.

4. The method of claim 3, wherein the player is presented with the prize wheel in exchange for the player viewing an advertisement.

5. The method of claim 4, further comprising varying prizes on the prize wheel available to be won by the player according to a schedule.

6. The method of claim 4, further comprising varying the number of prize wheel segments according to a schedule.

7. The method of claim 4, further comprising varying the number of prize wheel segments to be populated with cash prizes, according to a schedule.

8. The method of claim 4, further comprising varying values of the cash prizes according to a schedule.

9. A computer-hosted sweepstakes, comprising a prize wheel game in which a virtual prize wheel having segments populated with prizes available to be won by a player is presented to a player via a web site hosted at a first computer system; a first spin of the prize wheel determines how one or more segments of the prize wheel are populated; and a second spin of the prize wheel determines which of the prizes is won by the player, wherein one or more of the number of prize wheel segments, the number of prize wheel segments populated with cash prizes, and values of the cash prizes are varied according to a predetermined schedule, with the prizes, prize values and number of prize wheel segments being reset to a set of initial conditions if the player fails to participate in a qualifying event for a prize wheel turn within a designated time period.
